(19) United States
(12) Patent Application Publication
(10) Pub. No.: US 2012/0210968 A1
(43) Pub. Date: Aug. 23, 2012

(54) CORONA IGNITER WITH IMPROVED CORONA CONTROL

(76) Inventors: John Antony Burrows, Northwich (GB); James D. Lykowski, Temperance, MI (US); Keith Hampton, Arbor, MI (US)

(21) Appl. No.: 13/325,433

(22) Filed: Dec. 14, 2011

Related U.S. Application Data
(60) Provisional application No. 61/422,838, filed on Dec. 14, 2010.
(60) Provisional application No. 61/432,641, filed on Jan. 14, 2011.

(51) Int. Cl. F02P 23/00; H01F 7/06; H01T 19/00

(52) U.S. Cl. 123/143 B; 361/233; 29/602.1

(57) ABSTRACT

A corona igniter 20 includes an electrode gap 28 between the central electrode 22 and the insulator 32 and a shell gap 30 between the insulator 32 and the shell 36. The gaps 28, 30 are filled with a filler material 40 to prevent corona discharge 24 in the gaps 28, 30 and to concentrate the energy at a firing tip 58 of the central electrode 22. The filler material 40 may be electrically insulating or conductive. The shell gap width wₛ may be greatest at a shell lower end 92. The shell gap 30 may also be in a turnover region between a shell upper end 44 and the insulator 32, in which case the filler material 40 is injection molded around the turnover region. During operation of the igniter 20, the filler material 40 provides a reduced voltage drop across the gap 28, 30.

### CROSS REFERENCE TO RELATED APPLICATION

This application claims the benefit of U.S. provisional application Ser. No. 61/422,838, filed Dec. 14, 2010.

### BACKGROUND OF THE INVENTION

1. Field of the Invention

This invention relates generally to a corona igniter for emitting a radio frequency electric field to ionize a fuel-air mixture and provide a corona discharge, and a method of forming the corona igniter.

2. Related Art

Corona discharge ignition systems provide an alternating voltage and current, reversing high and low potential electrodes in rapid succession which makes arc formation difficult and enhances the formation of corona discharge. The system includes a corona igniter with a central electrode charged to a high radio frequency voltage potential and creating a strong radio frequency electric field in a combustion chamber. The electric field causes a portion of a mixture of fuel and air in the combustion chamber to ionize and begin dielectric breakdown, facilitating combustion of the fuel-air mixture. The electric field is preferably controlled so that the fuel-air mixture maintains dielectric properties and corona discharge occurs, also referred to as a non-thermal plasma. The ionized portion of the fuel-air mixture forms a flame front which then becomes self-sustaining and combusts the remaining portion of the fuel-air mixture. Preferably, the electric field is controlled so that the fuel-air mixture does not lose all dielectric properties, which would create a thermal plasma and an electric arc between the electrode and grounded cylinder walls, piston, or other portion of the igniter. An example of a corona discharge ignition system is disclosed in U.S. Pat. No. 6,883,507 to Freen.

The corona igniter typically includes the central electrode formed of an electrically conductive material for receiving the high radio frequency voltage and emitting the radio frequency electric field into the combustion chamber to ionize the fuel-air mixture and provide the corona discharge. An insulator formed of an electrically insulating material surrounds the central electrode and is received in a metal shell. The igniter of the corona discharge ignition system does not include any grounded electrode element intentionally placed in close proximity to a firing end of the central electrode. Rather, the ground is preferably provided by cylinder walls or a piston of the ignition system. An example of a corona igniter is disclosed in U.S. Patent Application Publication No. 2010/0083942 to Lykowski and Hampton.

The corona igniter may be assembled such that the clearance between the components results in small air gaps, for example an air gap between the central electrode and the insulator, and also between the insulator and the shell. These gaps are filled with air and gases from the surrounding manufacturing environment and during operation, gases from the combustion chamber. During use of the corona igniter, when energy is supplied to the central electrode, the electrical potential and the voltage drops significantly across the air gaps. The significant drop is due to the low relative permittivity of air.

FIG. 14 illustrates that the high voltage drop across the air gaps leads to a spike in electric field strength at the gaps, which tends to ionize the air in the gaps leading to significant energy loss at the firing end of the igniter. In addition, the ionized air in the gaps is prone to migrating toward the central electrode firing end, forming a conductive path across the insulator to the shell or the cylinder head, and reducing the effectiveness of the corona discharge at the central electrode firing end. The conductive path across the insulator may lead to arcing between those components, which is oftentimes undesired and reduces the quality of ignition at the central electrode firing end.

### SUMMARY OF THE INVENTION

One aspect of the invention provides a corona igniter for providing a corona discharge. The corona igniter includes a central electrode formed of an electrically conductive material for receiving a high radio frequency voltage and emitting a radio frequency electric field to ionize a fuel-air mixture and provide the corona discharge. The central electrode extends from an electrode terminal end receiving the high radio frequency voltage to an electrode firing end emitting the radio frequency electric field. An insulator is formed of an electrically insulating material and is disposed around the central electrode and extends longitudinally from an insulator upper end past the electrode terminal end to an insulator nose end. The insulator is spaced from the central electrode at the insulator nose end to provide an electrode gap therebetween. A shell formed of an electrically conductive metal material is disposed around the insulator and extends longitudinally from a shell upper end to a shell lower end. The shell is spaced from the insulator along at least one of the shell ends to provide a shell gap therebetween. A filler material extends continuously across at least one of the gaps for preventing corona discharge in the gap.

Another aspect of the invention provides a corona ignition system including the corona igniter.

Yet another aspect of the invention provides a method of forming the corona igniter. The method includes inserting the central electrode into a bore of the insulator and spacing the central electrode from the insulator at the insulator nose end to provide the electrode gap therebetween. Next the method includes inserting the insulator into a bore of the shell and spacing the insulator from the shell to provide the shell gap therebetween. The method then includes filling at least one of the gaps with a filler material.

The filler material keeps air and gas from the surrounding manufacturing environment and the combustion chamber out of the gaps, and thus prevents the formation of ionized gas between the central electrode and the insulator or between the insulator and the shell, both of which can form a conductive path, corona discharge, or arcing between the central electrode and the cylinder head. The filler material prevents ionization in the gaps and prevents energy from flowing through the gaps. Thus, the corona igniter provides a more concentrated corona discharge at the central electrode firing end and a more robust ignition, compared to corona igniters of the prior art.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a cross-sectional view of a corona igniter disposed in a combustion chamber according to one embodiment of the invention;

FIG. 1A is an enlarged cross-section view of a turnover region the corona igniter of FIG. 1;

FIG. 2 is a cross-sectional view of a corona igniter disposed in a combustion chamber according to another embodiment of the invention;

FIG. 3 is an enlarged view of a portion of a corona igniter according to one embodiment of the invention showing an unfilled electrode gap and a filled shell gap and graphs showing the associated voltage and electric field;

FIG. 4 is an enlarged view of a portion of a corona igniter according to another embodiment of the invention showing a filled electrode gap and a filled shell gap and graphs showing the associated voltage and electric field;

FIG. 5 is an enlarged view of an insulator nose region according to one embodiment of the invention;

FIG. 5A is an enlarged view of the electrode gap of FIG. 5;

FIG. 5B is an enlarged view of the shell gap of FIG. 5;

FIG. 6 is an enlarged view of the shell gap of FIG. 5 showing geometry details;

FIGS. 7-10 are example shell gap geometries according to embodiments of the invention;

FIG. 11 is an enlarged view of a turnover region according to one embodiment of the invention;

FIG. 12 is an insulator nose region of a corona igniter with unfilled air gaps;

FIG. 13 is an enlarged view of a portion of the corona igniter of FIG. 12 showing an unfilled electrode gap and an unfilled shell gap and a graph showing the associated voltage; and

FIG. 14 is an enlarged view of a portion of the corona igniter of FIG. 12 showing an unfilled electrode gap and an unfilled shell gap and a graph showing the associated electric field.

### DETAILED DESCRIPTION OF THE ENABLING EMBODIMENTS

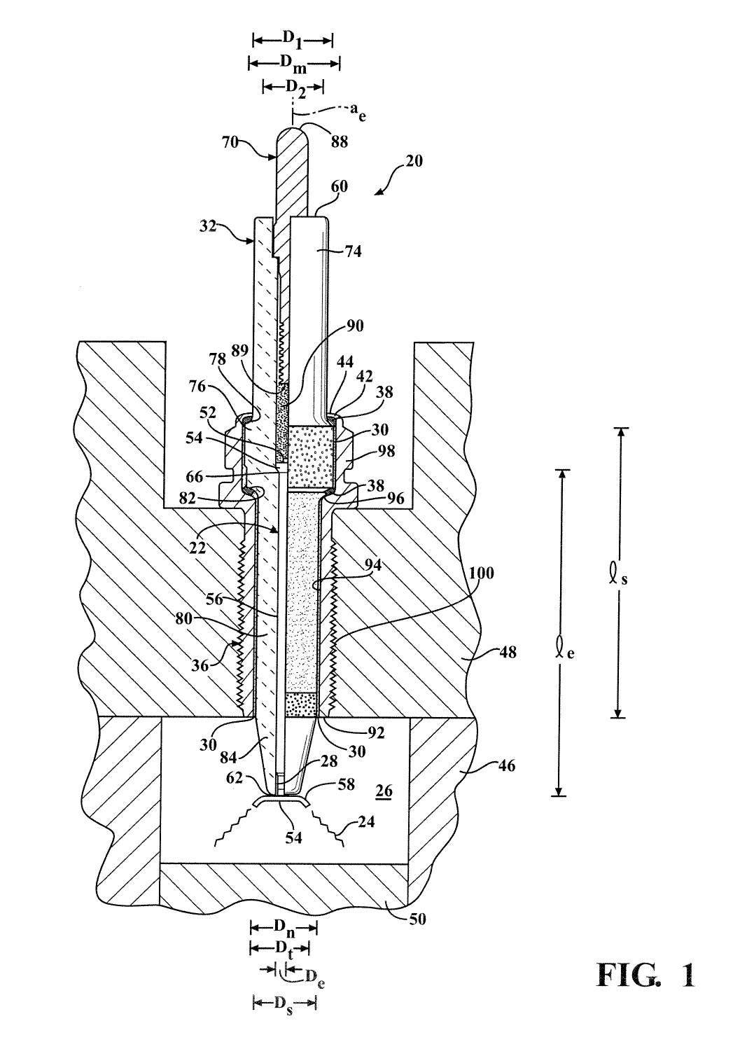

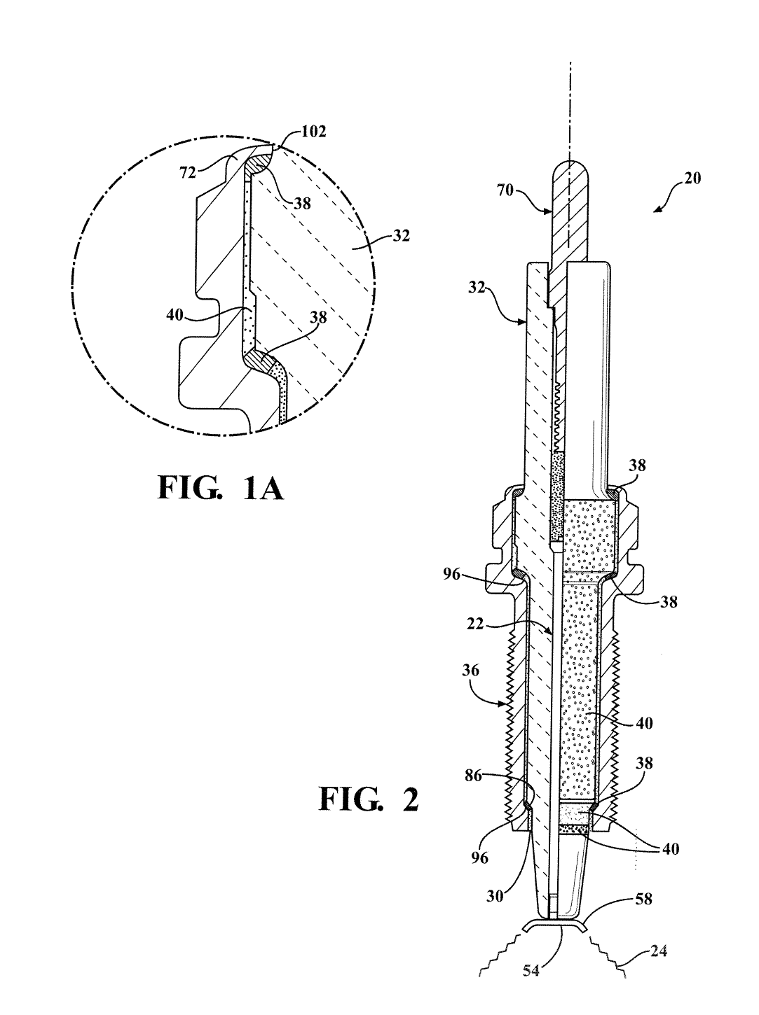

One aspect of the invention provides a corona igniter 20 for a corona discharge ignition system, as shown in FIG. 1. The system intentionally creates an electrical source which suppresses the formation of an arc and promotes the creation of strong electrical fields which produce corona. The ignition event of the corona discharge ignition system includes multiple electrical discharges running at approximately 1 megahertz.

The igniter 20 of the system includes a central electrode 22 for receiving energy at a high radio frequency voltage and emitting a radio frequency electric field to ionize a portion of a combustible fuel-air mixture and provide a corona discharge 24 in a combustion chamber 26 of an internal combustion engine. The corona igniter 20 is assembled such that the clearance between the central electrode 22, insulator 32, and shell 36 results in small air gaps. The assembly method first includes inserting the central electrode 22 into the insulator 32 such that a head 34 of the central electrode 22 rests on an electrode seat 66 along a bore of the insulator 32 and the other sections of the central electrode 22 are spaced from the insulator 32. An electrode gap 28 is provided between the electrode 22 and the insulator 32, allowing air to flow between the electrode 22 and insulator 32. In one preferred embodiment, the insulator 32 is inserted into the metal shell 36 with an internal seal 38 spacing the insulator 32 from the shell 36. A shell gap 30 extends continuously between the insulator 32 and shell 36, allowing air to flow between the insulator 32 and shell 36. The air gaps 28, 30 are then filled with a filler material 40 to prevent corona discharge 24 from forming in the air gaps 28, 30.

The shell 36 also includes a turnover lip 42 at a shell upper end 44 extending inwardly toward and annularly around the insulator 32, creating the shell gap 30 between the turnover lip 42 and the insulator 32. In one preferred embodiment, the filler material 40 is a resin injection molded around the turnover lip 42 and filling the shell gap 30, as shown in FIG. 11, to prevent corona discharge 24 from forming between the insulator 32 and the shell 36 in the turnover region.

The corona igniter 20 is typically used in an internal combustion engine of an automotive vehicle or industrial machine. As shown in FIG. 1, the corona igniter 20 is disposed in a cylinder block 46 having a side wall extending circumferentially around a cylinder center axis and presenting a space having a cylindrical shape. The side wall of the cylinder block 46 has a top end surrounding a top opening, and a cylinder head 48 is disposed on the top end and extends across the top opening. A piston 50 is disposed in the cylindrical space and along the side wall of the cylinder block 46 for sliding along the side wall during operation of the internal combustion engine. The piston 50 is spaced from the cylinder head 48 such that the cylinder block 46 and the cylinder head 48 and the piston 50 provide the combustion chamber 26 therebetween. The combustion chamber 26 contains the combustible fuel-air mixture ionized by the corona igniter 20. The cylinder head 48 includes an access port receiving the igniter 20, and the igniter 20 extends transversely into the combustion chamber 26. The igniter 20 receives a high radio frequency voltage from a power source (not shown) and emits the radio frequency electric field to ionize a portion of the fuel-air mixture and form the corona discharge 24.

The central electrode 22 of the igniter 20 extends longitudinally along an electrode center axis aₑ from an electrode terminal end 52 to an electrode firing end 54. Energy at the high radio frequency AC voltage is applied to the central electrode 22 and the electrode terminal end 52 receives the energy at the high radio frequency AC voltage, typically a voltage up to 40,000 volts, a current below 1 ampere, and a frequency of 0.5 to 5.0 megahertz. The highest voltage applied to the central electrode 22 is referred to as a maximum voltage. The electrode 22 includes an electrode body portion 56 formed of an electrically conductive material, such as nickel. The electrode body portion 56 can also include a core formed of another electrically conductive material, such as copper. In one embodiment, the materials of the electrode 22 have a low electrical resistivity of below 1,200 nΩ·m. The electrode body portion 56 presents an electrode diameter Dₑ being perpendicular to the electrode center axis aₑ. The electrode body portion 56 includes the electrode head 34 at the electrode terminal end 52. The head 34 has an electrode diameter Dₑ greater than the electrode diameter Dₑ along the remaining sections of the electrode body portion 56.

According to one preferred embodiment, the central electrode 22 includes a firing tip 58 surrounding and adjacent the electrode firing end 54 for emitting the radio frequency electric field to ionize a portion of the fuel-air mixture and provide the corona discharge 24 in the combustion chamber 26. The firing tip 58 is formed of an electrically conductive material providing exceptional thermal performance at high temperatures, for example a material including at least one element selected from Groups 4-12 of the Periodic Table of the Elements. As shown in FIG. 1, the firing tip 58 presents a tip diameter Dₜ that is greater than the electrode diameter Dₑ of the electrode body portion 56.

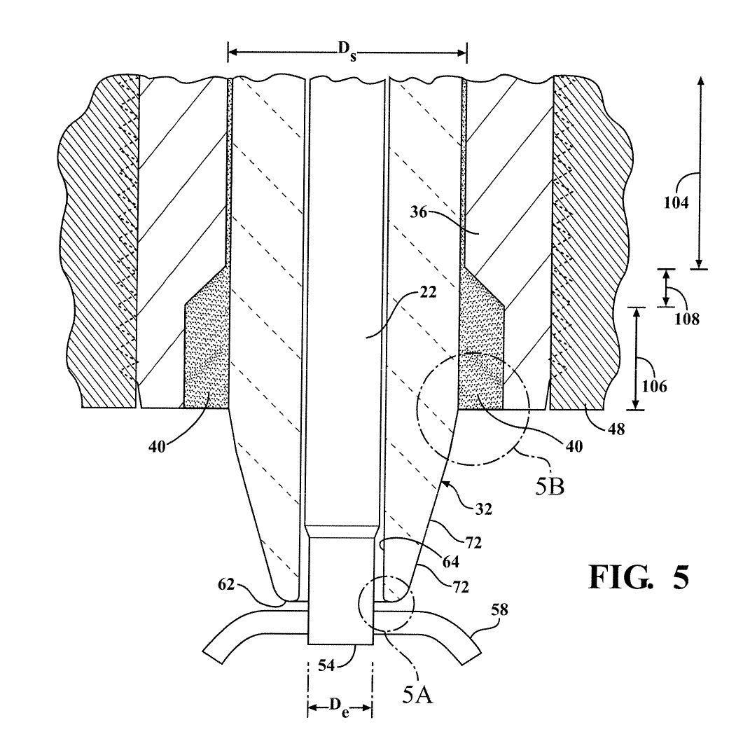

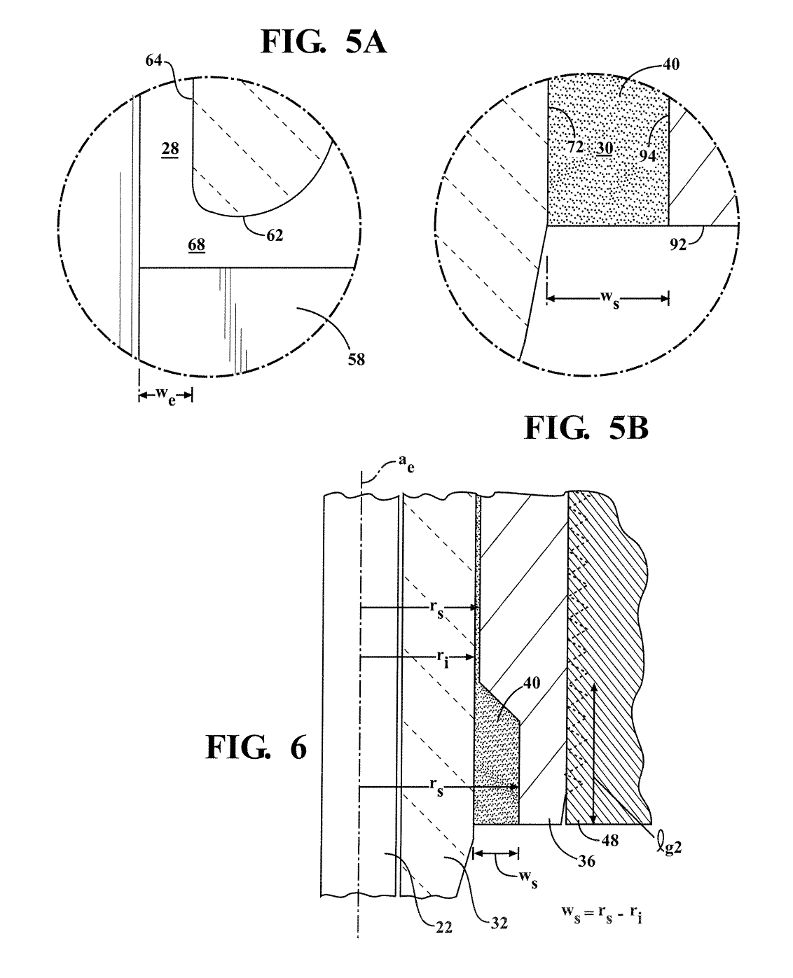

The insulator 32 of the corona igniter 20 is disposed annularly around and longitudinally along the electrode body portion 56. The insulator 32 extends from an insulator upper end 60 to an insulator nose end 62 spaced from the electrode firing end 54 and the firing tip 58 of the electrode 22. FIGS. 5 and 6 are enlarged views of the insulator nose end 62 according to two embodiments of the invention. According to another embodiment (not shown), the firing tip 58 abuts the insulator 32 so that there is no space therebetween.

The insulator 32 is formed of an electrically insulating material, typically a ceramic material including alumina. The insulator 32 has an electrical conductivity less than the electrical conductivity of the central electrode 22 and the shell 36. In one embodiment, the insulator 32 has a dielectric strength of 14 to 25 kV/mm. The insulator 32 also has a relative permittivity capable of holding an electrical charge, typically a relative permittivity of 6 to 12. In one embodiment, the insulator 32 has a coefficient of thermal expansion (CTE) between 2×10⁻⁶/° C. and 10×10⁻⁶/° C.

The insulator 32 includes an insulator inner surface 64 facing the electrode body portion 56 and extending longitudinally along the electrode center axis aₑ from the insulator upper end 60 to the insulator nose end 62. The insulator inner surface 64 presents an insulator bore receiving the central electrode 22 and includes the electrode seat 66 for supporting the head 34 of the central electrode 22.

The electrode firing end 54 is inserted through the insulator upper end 60 and into the insulator bore until the head 34 of the central electrode 22 rests on the electrode seat 66 along the bore of the insulator 32. The remaining sections of the electrode body portion 56 below the head 34 are spaced from the insulator inner surface 64 to provide the electrode gap 28 therebetween. The corona igniter 20 is also assembled so that the electrode firing end 54 and the firing tip 58 are disposed outwardly of the insulator nose end 62, as best shown in FIGS. 5 and 6. The insulator nose end 62 and the firing tip 58 present a tip space 68 therebetween allowing ambient air to flow between the insulator nose end 62 and the firing tip 58.

The electrode gap 28 between the insulator inner surface 64 and the electrode body portion 56 extends continuously along the electrode body portion 56 from the electrode firing end 54 to the enlarged head 34, and also annularly around the electrode body portion 56. In one embodiment, the electrode body portion 56 has a length lₑ, and the electrode gap 28 extends longitudinally along at least 80% of the length lₑ. The electrode gap 28 has an electrode gap width wₑ extending perpendicular to the electrode center axis aₑ and radially from the electrode body portion 56 to the insulator 32, as shown in FIG. 5A. In one embodiment, the electrode gap width wₑ is 0.025 mm to 0.25 mm.

Prior to filling the electrode gap 28, the electrode gap 28 is open at the insulator nose end 62 and in fluid communication with the tip space 68. Thus, air from the surrounding environment can flow along the firing tip 58 through the tip space 68 and into the electrode gap 28 up to the head 34 of the electrode 22. Without the filler material 40, the entire electrode gap 28 would be exposed to the combustion such that the fuel-air mixture could also flow through the electrode gap 28 to the electrode head 34.

The insulator 32 of the corona igniter 20 includes an insulator outer surface 72 opposite the insulator inner surface 64 extending longitudinally along the electrode center axis aₑ from the insulator upper end 60 to the insulator nose end 62. The insulator outer surface 72 faces outwardly toward the shell 36 and away from the central electrode 22. In one preferred embodiment, the insulator 32 is designed to fit securely in the shell 36 and allow for an efficient manufacturing process.

As shown in FIG. 1, the insulator 32 includes an insulator first region 74 extending along the electrode body portion 56 from the insulator upper end 60 toward the insulator nose end 62. The insulator first region 74 presents an insulator first diameter D₁ extending generally perpendicular to the electrode center axis aₑ. The insulator 32 also includes an insulator middle region 76 adjacent the insulator first region 74 extending toward the insulator nose end 62. The insulator middle region 76 also presents an insulator middle diameter Dₘ extending generally perpendicular to the electrode center axis aₑ, and the insulator middle diameter Dₘ is greater than the insulator first diameter D₁. An insulator upper shoulder 78 extends radially outwardly from the insulator first region 74 to the insulator middle region 76.

The insulator 32 also includes an insulator second region 80 adjacent the insulator middle region 76 extending toward the insulator nose end 62. The insulator second region 80 presents an insulator second diameter D₂ extending generally perpendicular to the electrode center axis aₑ, which is less than the insulator middle diameter Dₘ. An insulator lower shoulder 82 extends radially inwardly from the insulator middle region 76 to the insulator second region 80.

The insulator 32 further includes an insulator nose region 84 extending from the insulator second region 80 to the insulator nose end 62. The insulator nose region 84 presents an insulator nose diameter Dₙ extending generally perpendicular to the electrode center axis aₑ and tapering to the insulator nose end 62. In the embodiment of FIG. 2, the insulator 32 includes an insulator nose shoulder 86 extending radially inwardly from the insulator second region 80 to the insulator nose region 84. The insulator nose diameter Dₙ at the insulator nose end 62 is less than the insulator second diameter D₂ and less than the tip diameter Dₜ of the firing tip 58.

As shown in FIGS. 1 and 2, the corona igniter 20 includes a terminal 70 formed of an electrically conductive material received in the insulator 32. The terminal 70 includes a first terminal end 88 electrically connected to a terminal wire (not shown), which is electrically connected to the power source (not shown). The terminal 70 also includes an electrode terminal end 89, which is in electrical communication with the electrode 22. Thus, the terminal 70 receives the high radio frequency voltage from the power source and transmits the high radio frequency voltage to the electrode 22. A conductive seal layer 90 formed of an electrically conductive material is disposed between and electrically connects the terminal 70 and the electrode 22 so that the energy can be transmitted from the terminal 70 to the electrode 22.

The shell 36 of the corona igniter 20 is disposed annularly around the insulator 32. The shell 36 is formed of an electrically conductive metal material, such as steel. In one embodiment, the shell 36 has a low electrical resistivity below 1,000 nΩ·m. As shown in FIG. 1, the shell 36 extends longitudinally along the insulator 32 from a shell upper end 44 to a shell lower end 92. The shell 36 includes a shell inner surface 94 facing the insulator outer surface 72 and extending longitudinally from the insulator first region 74 along the insulator upper shoulder 78 and the insulator middle region 76 and the insulator lower shoulder 82 and the insulator second region 80 to the shell lower end 92 adjacent the insulator nose region 84. The shell inner surface 94 presents a shell bore receiving the insulator 32. The shell inner surface 94 also presents a shell diameter Dₛ extending across the shell bore. The shell diameter Dₛ is greater than the insulator nose diameter Dₙ such that the insulator 32 can be inserted in the shell bore and at least a portion of the insulator nose region 84 projects outwardly of the shell lower end 92.

The shell inner surface 94 presents at least one shell seat 96 for supporting the insulator lower shoulder 82 or the insulator nose shoulder 86, or both. In the embodiment of FIG. 1, the shell 36 includes one shell seat 96 disposed adjacent a tool receiving member 98 and supporting the insulator lower shoulder 82. In the embodiment of FIG. 2, the shell 36 includes two shell seats 96, one disposed adjacent the tool receiving member 98 and another disposed adjacent the shell lower end 92 for supporting the insulator nose shoulder 86.

In one embodiment, the corona igniter 20 includes at least one of the internal seals 38 disposed between the shell inner surface 94 and the insulator outer surface 72 to support the insulator 32 once the insulator 32 is inserted into the shell 36. The internal seals 38 space the insulator outer surface 72 from the shell inner surface 94 to provide the shell gap 30 therebetween. When the internal seals 38 are employed, the shell gap 30 typically extends continuously from the shell upper end 44 to the shell lower end 92. As shown in FIG. 1, one of the internal seals 38 is typically disposed between the insulator outer surface 72 of the insulator lower shoulder 82 and the shell inner surface 94 of the shell seat 96 adjacent the tool receiving member 98. In the embodiment of FIG. 2, one of the internal seals 38 is also disposed between the insulator outer surface 72 of the insulator nose shoulder 86 and the shell inner surface 94 of the shell seat 96 adjacent the insulator nose region 84. The embodiments of FIGS. 1 and 2 also include one of the internal seals 38 between the insulator outer surface 72 of the insulator upper shoulder 78 and the shell inner surface 94 of the turnover lip 42 of the shell 36. The internal seals 38 are positioned to provide support and maintain the insulator 32 in position relative to the shell 36.

The insulator 32 rests on the internal seals 38 disposed on the shell seats 96. In the embodiments of FIGS. 1 and 2, the remaining sections of the insulator 32 are spaced from the shell inner surface 94, such that the insulator outer surface 72 and the shell inner surface 94 present the shell gap 30 therebetween. The shell gap 30 extends continuously along the insulator outer surface 72 from the insulator upper shoulder 78 to the insulator nose region 84, and also annularly around the insulator 32. As shown in FIG. 1, the shell 36 has a length lₛ, and the shell gap 30 typically extends longitudinally along at least 80% of the length lₛ. When the internal seals 38 are used, the shell gap 30 can extend along 100% of the length lₛ of the shell 36. The shell gap 30 also has a shell gap width wₛ extending perpendicular to the electrode center axis aₑ and radially from the insulator outer surface 72 to the shell inner surface 94. In one embodiment, the shell gap width wₛ is 0.075 mm to 0.300 mm. The shell gap 30 may be enlarged near the electrode firing end 54 by modifying the shell 36 or the insulator 32. The enlarged area may increase the shell gap 30 up to 1 mm or more.

The shell gap 30 is open at the shell lower end 92 such that prior to filling the shell gap 30, air from the surrounding environment can flow into the shell gap 30 and along the insulator outer surface 72 up to the internal seals 38. Without the filler material 40, the entire shell gap 30 from the shell lower end 92 or the shell upper end 44 to the internal seals 38 would be exposed to the combustion such that the fuel-air mixture could also flow through the shell gap 30 to the internal seals 38.

In an alternate embodiment, the insulator outer surface 72 rests on the shell seat 96 without the internal seals 38. In this embodiment, the shell gap 30 may only be located at the shell upper end 44 or along certain portions of the insulator outer surface 72, but not continuously between the shell upper end 44 and the shell lower end 92.

The shell 36 also includes a shell outer surface 100 opposite the shell inner surface 94 extending longitudinally along the electrode center axis aₑ from the shell upper end 44 to the shell lower end 92 and facing outwardly away from the insulator 32. The shell 36 includes the tool receiving member 98, which can be employed by a manufacturer or end user to install and remove the corona igniter 20 from the cylinder head 48. The tool receiving member 98 extends along the insulator middle region 76 from the insulator upper shoulder 78 to the insulator lower shoulder 82. The tool receiving member 98 presents a tool thickness extending generally perpendicular to the longitudinal electrode body portion 56. In one embodiment, the shell 36 also includes threads along the insulator second region 80 for engaging the cylinder head 48 and maintaining the corona igniter 20 in a desired position relative to the cylinder head 48 and the combustion chamber 26.

The turnover lip 42 of the shell 36 extends longitudinally from the tool receiving member 98 along the insulator outer surface 72 of the insulator middle region 76, and then and inwardly along the insulator upper shoulder 78 to the shell upper end 44 adjacent the insulator first region 74. The turnover lip 42 extends annularly around the insulator upper shoulder 78 so that the insulator first region 74 projects outwardly of the turnover lip 42. A portion of the shell inner surface 94 along the turnover lip 42 engages the insulator middle region 76 and helps fix the shell 36 against axial movement relative to the insulator 32.

The shell gap 30 is typically located between the shell 36 and insulator 32 in the turnover region and also at the shell lower end 92 up to the internal seals 38. As best shown in FIG. 1A and, the turnover lip 42 of the shell 36 includes a lip surface 102 between the shell inner surface 94 and the shell outer surface 100 facing the insulator outer surface 72 of the insulator first region 74. The turnover lip 42 has a lip thickness extending from the shell inner surface 94 to the shell outer surface 100, which is typically less than the tool thicknesses. In one embodiment, the entire lip surface 102 engages the insulator outer surface 72 and the shell gap 30 is located between the shell outer surface 100 along the turnover lip 42 and the insulator 32. In another embodiment, the lip surface 102 is completely spaced from the shell outer surface 100 and the shell gap 30 is provided between the lip surface 102 and the insulator 32. In the embodiment of FIG. 11, a portion of the lip surface 102 engages the insulator outer surface 72 and the shell gap 30 is provided between a portion of the lip surface 102 and the insulator 32.

Prior to filling the shell gap 30 with the filler material 40, the shell gap 30 is open at the shell upper end 44 in the turnover region such that air from the surrounding environment can flow therein.

The filler material 40 is disposed in at least one of the gaps 28, 30 of the igniter 20, and preferably both the electrode gap 28 and the shell gap 30. It can be disposed in the shell gap 30 at the shell lower end 92 and also at the shell upper end 44 in the turnover region. The filler material 40 extends continuously across the electrode gap 28 and the shell gap 30 to prevent corona discharge 24 from forming in the gaps 30. The filler material 40 is a separate component, distinct from the central electrode 22, the insulator 32, the internal seals 38, and the shell 36. The filler material 40 provides a hermetic seal from air and other gases of the surrounding environment across the electrode gap 28 and the shell gap 30.

The filler material 40 can be either electrically insulating or electrically conductive. It can include a single material or it can include several materials, such as different materials in different areas of the corona igniter 20. During operating of the corona igniter 20, when energy is supplied to the electrode 22 at a voltage up to 40,000 volts, a current below 1 ampere, and a frequency of 0.5 to 5.0 megahertz, the energy flows through the corona igniter 20 to the filler material 40, and the filler material 40 is capable of holding the energy at a frequency of not greater than 5 MHz.

In one embodiment, the filler material 40 is electrically insulating and has a relative permittivity of 1 to 6 so that the filler material 40 and the insulator 32 have a relative permittivity difference of not greater than 10. A filler material 40 having a permittivity similar to the insulator 32 is preferred. In another embodiment, the filler material 40 is either electrically insulating or conductive and has a coefficient of thermal expansion between 2×10⁻⁶/° C. and 20×10⁻⁶/° C. so that the filler material 40 and the insulator 32 have a coefficient of thermal expansion difference of not greater than 10×10⁻⁶/° C.

The filler material 40 is disposed in the electrode gap 28 adjacent the electrode firing end 54 and extends continuously across the electrode gap width wₑ from the electrode body portion 56 to the insulator inner surface 64. In one embodiment, the filler material 40 fills the entire electrode gap 28 by extending continuously along the electrode body portion 56 from the electrode firing end 54 to the head 34 of the electrode 22. In another embodiment, the filler material 40 fills a portion of the electrode gap 28 by extending along portions of the electrode body portion 56 between the electrode firing end 54 and the head 34. For example, the electrode gap 28 has a volume, and the filler material 40 fills at least 50% and preferably at least 80% of the volume of the electrode gap 28. The filler material 40 can be spaced from the firing tip 58 of the electrode 22 or can touch the firing tip 58 of the electrode 22.

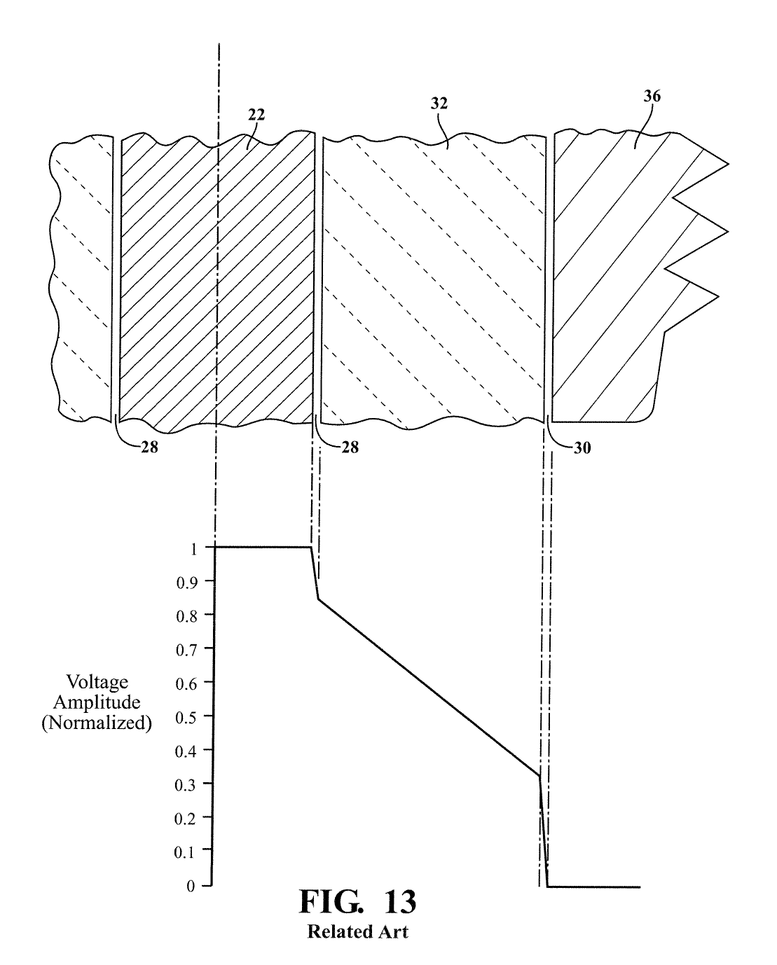

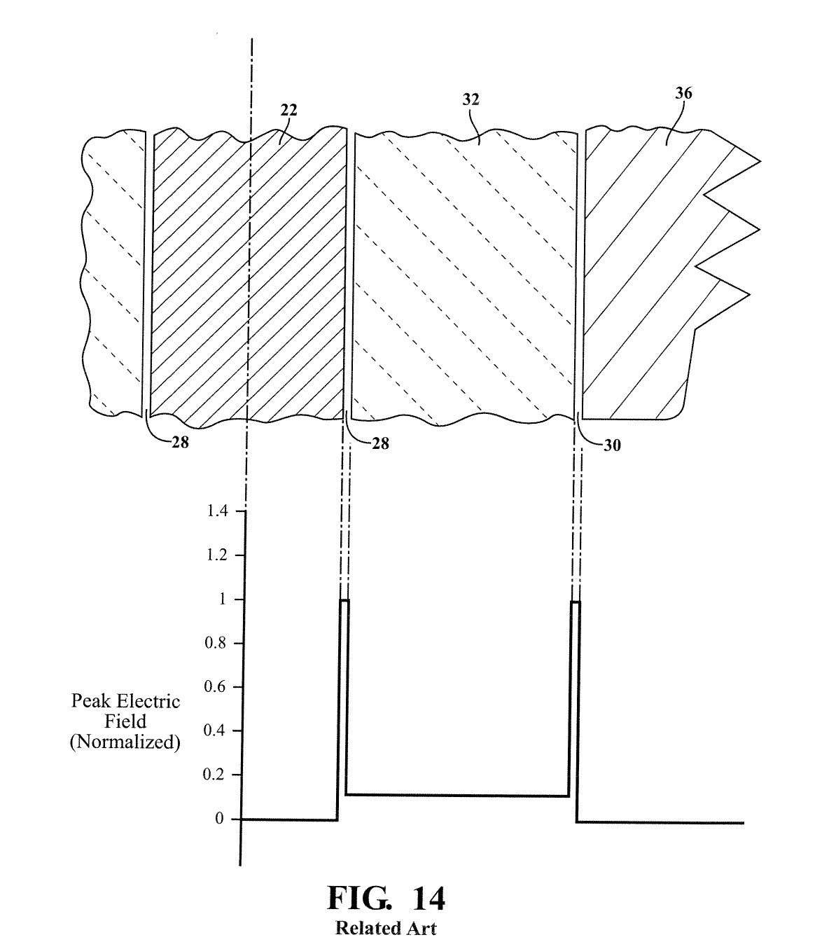

Filling the electrode gap 28 with the filler material 40 provides significant advantages. In the comparative corona igniter of FIGS. 12-14, without the filler material 40, there is a large difference between the permittivity of the insulator 32 and the air in the electrode gap 28. Thus, the voltage drops sharply at the electrode gap 28 and typically decreases by 10 to 20% of a total voltage drop from the central electrode 22 to the grounded metal shell 36. The electric field also increases sharply at the electrode gap 28. The electric field strength in the unfilled electrode gap 28 is typically 5 to 10 times higher than the electric field strength of the insulator 32.

The filler material 40 of the present invention reduces the electric field in the electrode gap 28 and reduces the voltage variance across the electrode gap 28. In one embodiment, the filler material 40 has voltage decreasing across the electrode gap 28 by not greater than 5% of the maximum voltage applied to the central electrode 22. The voltage drop across the filled electrode gap 28 is not greater than 5% of the total voltage drop from the central electrode 22 to the grounded metal shell 30.

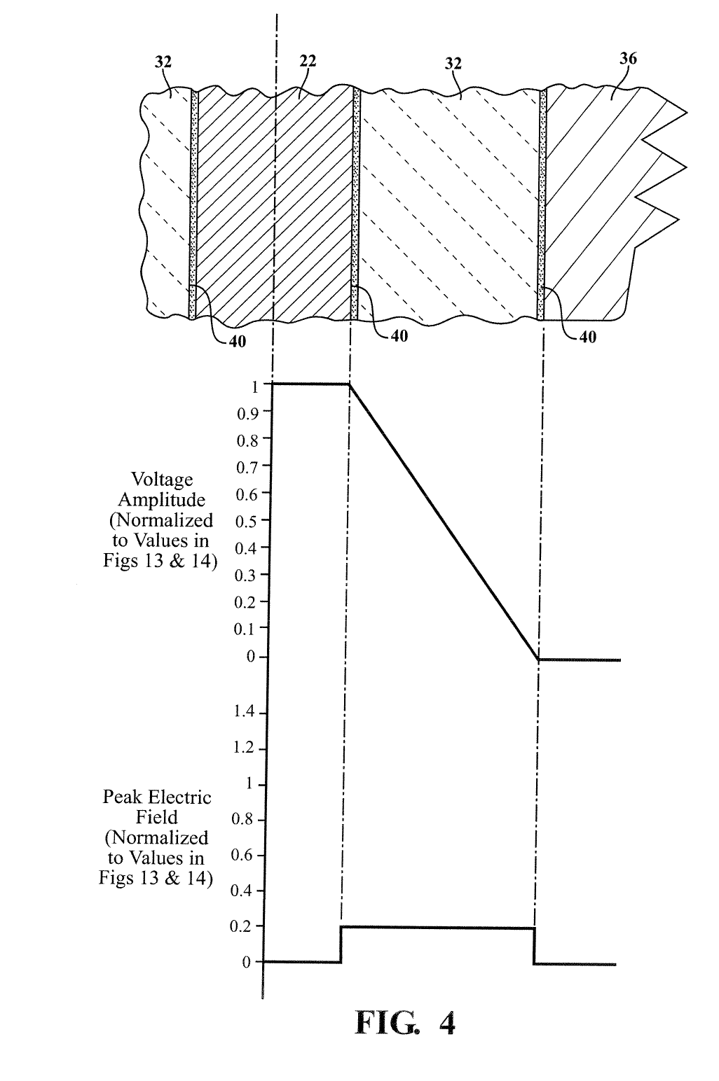

The filler material 40 also reduces the electric field spike in the electrode gap 28. The electric field strength of the filled electrode gap 28 is typically not greater than one times higher than the electric field strength of the insulator 32, when a current of energy at a frequency of 0.5 to 5.0 megahertz flows through the central electrode 22. As shown in FIG. 4, the voltage typically decreases gradually across the filled electrode gap 28 and the peak electric field remains constant across the filled electrode gap 28. For example, a portion of the electrode body portion 56 adjacent the filler material 40 has a voltage and a portion of the insulator 32 adjacent the filler material 40 has a voltage, and the difference between the voltages is not greater than 5% of the maximum voltage applied to the central electrode 22, or not greater than 5% of the total voltage drop from the central electrode 22 to the grounded metal shell 30, when a current of energy at a frequency of 0.5 to 5.0 megahertz flows through the central electrode 22.

The shell gap 30 is also filled with the filler material 40, preferably adjacent the shell lower end 92 and the upper shell 36 end. The filler material 40 extends continuously across the shell gap width wₛ from the insulator outer surface 72 to the shell inner surface 94. In one embodiment, the filler material 40 fills the entire shell gap 30 by extending continuously from the shell lower end 92 around the internal seals 38 to the shell upper end 44 and also around the turnover lip 42. In another embodiment, the filler material 40 fills a portion of the shell gap 30 by extending along portions of the insulator 32 between the insulator nose region 84 and the insulator upper shoulder 78 or along the turnover lip 42. For example, the shell gap 30 has a volume, and the filler material 40 fills at least 50% and preferably at least 80% of the volume of the shell gap 30.

The corona igniter 20 of FIG. 1 includes different types of filler materials 40 in different sections of the shell gap 30. One filler material 40 extends longitudinally from the shell lower end 92 toward the shell upper end 44, but is spaced from the tool receiving member 98. Another filler material 40 extends longitudinally from adjacent the first filler material 40 to the internal seal 38 at the insulator lower shoulder 82. A third filler material 40 then extends longitudinally from the internal seal 38 at the insulator lower shoulder 82 to the internal seal 38 at the insulator upper shoulder 78. There may be a small space between the second and third filler materials 40. The materials are selected based on characteristics of the corona igniter 20 in those regions.

The corona igniter 20 of FIG. 2 also includes different materials in different sections of the shell gap 30. One filler material 40 extends longitudinally from the shell lower end 92 to a section of the shell gap 30 spaced from the insulator nose shoulder 86. Another filler material 40 extends from the first filler material 40 to the insulator nose shoulder 86. A third filler material 40 extends from the shell seat 96 to the internal seal 38 at the insulator upper shoulder 78. There may be a small space between the second and third filler materials 40.

In one preferred embodiment, the shell gap width wₛ varies longitudinally along the shell gap 30. In one embodiment, shown in FIGS. 5-10, the shell gap width wₛ is greater at the shell lower end 92 than other portions of the shell gap 30. This design allows for more filler material 40 to be disposed at the shell lower end 92, which provides for convenient manufacturing and improves endurance of the filler material 40.

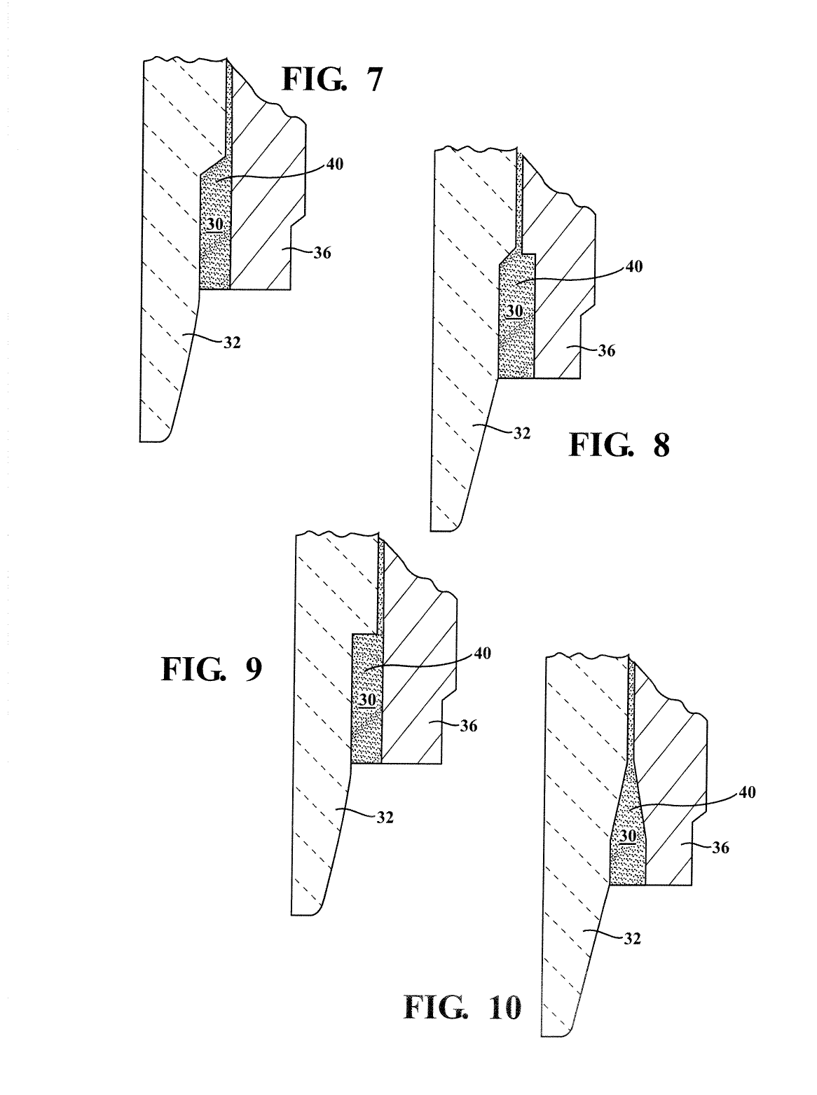

In certain embodiments, the shell gap 30 has a first gap region 104 and a second gap region 106, wherein the shell gap width wₛ of the second gap region 106 is greater than the shell gap width wₛ of the first gap region 104. In the embodiments of FIGS. 5 and 6, the shell gap width wₛ of the first gap region 104 is consistent from the insulator lower shoulder 82 along a portion of the insulator second region 80 to a location longitudinally spaced from the shell lower end 92. The second gap region 106 can extend from the first gap region 104 to the shell lower end 92 and can also be consistent. The shell gap 30 can also include a middle gap region 108 between the first gap region 104 and the second gap region 106, wherein the shell gap width wₛ of the middle gap region 108 increases gradually from the first gap region 104 to the second gap region 106. Alternatively, the shell gap width wₛ may increase sharply from the first gap region 104 to the second gap region 106. Other example designs of the shell gap 30 are shown in FIGS. 7-10.

The dimensions of the shell gap 30 are provided by the dimensions of the insulator 32 and the shell 36. As shown in FIG. 6, the igniter 20 presents an insulator radius rᵢ and a shell radius rₛ, and at least one of the radii rᵢ, rₛ vary to present the varying shell gap width wₛ. The insulator radius rᵢ extends from the electrode center axis aₑ to the insulator outer surface 72 and the shell radius rₛ extends from the electrode center axis aₑ to the shell inner surface 94. The shell radius rₛ and the insulator radius rᵢ may be consistent or vary along the first gap region 104 and the second gap region 106. Typically, the insulator radius rᵢ and the shell radius rₛ are consistent along the first gap region 104 and vary along the second gap region 106. The shell gap width wₛ is equal to the difference between the shell radius rₛ and the insulator radius rᵢ. The second gap region 106 has a shell gap length l_{g2} extending longitudinally from the first gap region 104 to the shell lower end 92. In one embodiment the shell gap length l_{g2} of the second gap region 106 is 5.0 mm, the insulator radius rᵢ is 3.68 mm, the shell radius rₛ of the first gap region 104 is 3.76 mm, the shell radius rᵢ of the second gap region 106 is 4.53 mm, the shell gap width wₛ of the first gap region 104 is 0.08 mm, and the shell gap width wₛ of the second gap region 106 is 0.85 mm.

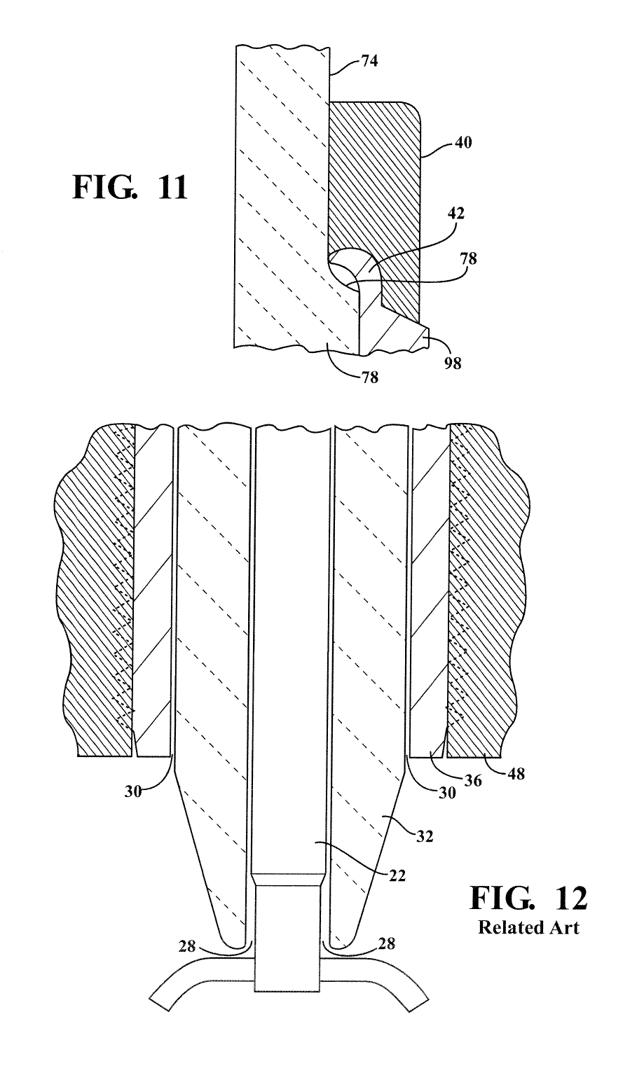

FIGS. 5-10 show example geometries of the shell gap 30 at the shell lower end 92. In the embodiment of FIGS. 5 and 6, the shell radius rₛ increases gradually to present the second gap region 106 and is then consistent from the increase to the shell lower end 92. In the embodiment of FIG. 7, the insulator radius rᵢ decreases gradually to present the second gap region 106 and is then consistent from the increase to the insulator nose region 84. In the embodiment of FIG. 8, the shell radius rₛ increases sharply and the insulator radius rᵢ increases gradually to present the second gap region 106. The insulator radius rᵢ is then consistent from the increase to the insulator nose region 84 and the shell radius rₛ is consistent from the increase to the shell lower end 92. In the embodiment of FIG. 9, the insulator radius rᵢ decreases sharply and is then consistent from the increase to the insulator nose region 84. In the embodiment of FIG. 10, the insulator radius rᵢ decreases gradually and the shell radius rₛ increases gradually to present the second gap region 106. The shell radius rₛ is then consistent from the increase to the shell lower end 92 and the insulator radius rᵢ is then consistent from increase to the insulator nose region 84.

Filling the shell gap 30 with the filler material 40 also provides significant advantages. In the comparative corona igniter of FIGS. 12-14, without the filler material 40, there is a large difference between the relative permittivity of the insulator 32 and the air in the shell gap 30. Thus, the voltage drops sharply at the shell gap 30 and typically decreases by 10 to 20% of a total voltage drop from the central electrode 22 to the grounded metal shell 36. The electric field strength also increases sharply at the shell gap 30. The electric field strength in the unfilled air gap 30 is typically 5 to 10 times higher than the electric field strength of the insulator 32.

The filled material 40 reduces the electric field across the shell gap 30 and reduces the voltage variance across the shell gap 30. In one embodiment, the filler material 40 has a voltage decreasing across the shell gap 30 by not greater than 5% of the maximum voltage applied to the central electrode 22. The filler material 40 has a voltage decreasing across the shell gap 30 by not greater than 5% of the maximum voltage applied to the central electrode 22. The voltage drop across the filled shell gap 30 is not greater than 5% of the total voltage drop from the central electrode 22 to the grounded metal shell 36.

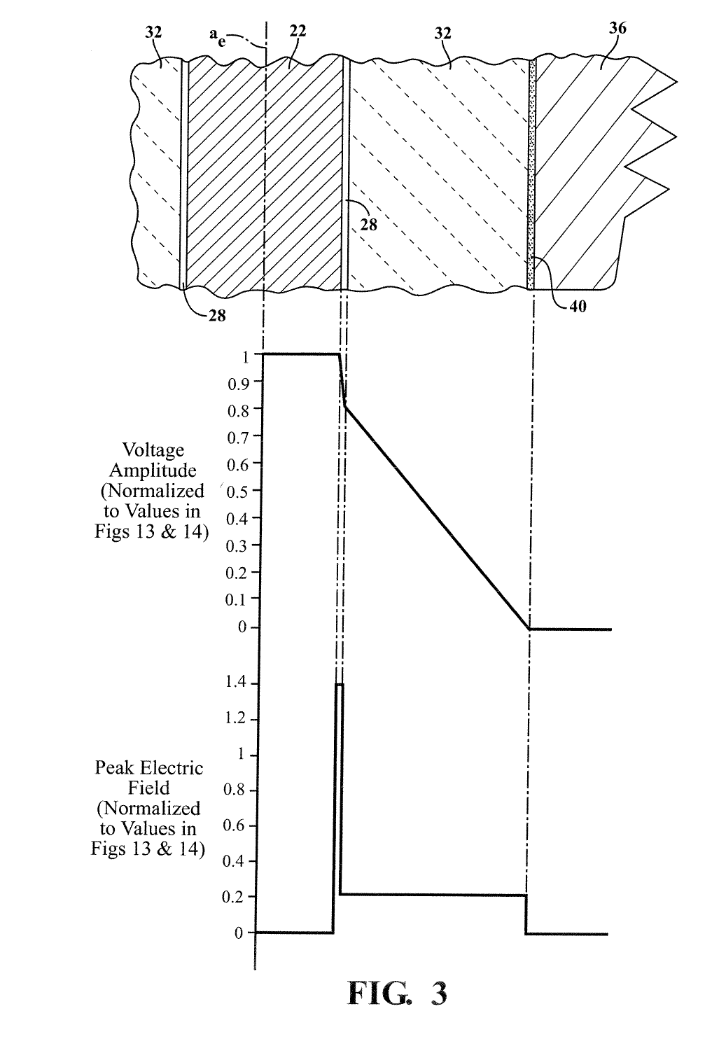

The filler material 40 also reduces the electric field spike across the shell gap 30. The electric field strength in the filled shell gap 30 is typically not greater than one times higher than the electric field strength of the insulator 32, when a current of energy at a frequency of 0.5 to 5.0 megahertz flows through the central electrode 22. As shown in FIGS. 3 and 4, the voltage typically decreases gradually across the shell gap 30 and the peak electric field remains constant across the shell gap 30. For example, a portion of the insulator 32 adjacent the filler material 40 has a voltage and a portion of the shell 36 adjacent the filler material 40 has a voltage, and the difference between the voltages is not greater than 5% of the maximum voltage applied to the central electrode 22, or not greater than 5% of the total voltage drop from the central electrode 22 to the grounded metal shell 30, when a current of energy at a frequency of 0.5 to 5.0 megahertz flows through the central electrode 22.

In one embodiment, the filler material 40 is electrically insulating and electrically isolates the insulator 32 to reduce energy loss and provides a slightly better energy efficiency than the electrically conductive filler materials 40. In one embodiment, the electrically insulating filler material 40 has a dielectric strength of 5 to 10 kV/mm. The filler material 40 is different from but compatible with the electrically insulating material of the insulator 32. Examples of the electrically insulating filler material 40 include a plastic, a resin, a heat-treated glass powder, and an adhesive, such as a high temperature alumina based adhesive having a thermal conductivity of at least 2 W/mK.

In one preferred embodiment, shown in FIG. 11, the filler material 40 is a resin and is injection molded around the turnover lip 42. The resin typically has a dielectric strength of 10 to 30 kV/mm and a specific gravity of 1.5 to 2. An example of the injection molded resin is a phenolic resin. Another example of the injection molded resin is a polyethylene terephthalate (PET) thermoplastic polyester resin containing uniformly dispersed glass fibers or a combination of mineral and glass fibers, such as Rynite®. The molded resin fills the shell gap 30 between the lip surface 102 and the insulator outer surface 72 of the insulator first region 74. The molded resin also extends along the insulator outer surface 72 of the insulator first region 74 and the shell outer surface 100 of the turnover lip 42

In another embodiment, the filler material 40 is electrically conductive. Examples of the electrically conductive filler material 40 include metals, such as chromium, and metal alloys, such as a chromium alloy, a nickel-cobalt ferrous alloy, for example Kovar, and stainless steel having a coefficient of thermal expansion of not greater than 18×10⁻⁶/° C. In one embodiment, the filler material 40 is a braze or a solder metal. Additionally, an adhesive filled with a conductive metal powder may be used.

Although the corona igniter 20 only requires one of the gaps 28, 30 to be filled with the filler material 40, filling both of the gaps 28, 30 is especially beneficial. As shown in FIG. 4, when both gaps 28, 30 are filled, the corona igniter 20 has a voltage decreasing gradually and consistently from the central electrode 22 across the electrode gap 28, the insulator 32, and the shell gap 30 to the shell 36. In addition, the electrode 22 field remains constant from the central electrode 22 across the electrode gap 28, the insulator 32, and the shell gap 30 to the shell 36.

The filler material 40 prevents an electric charge from being contained in the gaps 28, 30 and prevents electricity from flowing through the gaps 28, 30. The filler material 40 keeps air and gas from the combustion chamber 26 out of the gaps 28, 30 and thus prevents the formation of ionized gas which could form a conductive path and arcing across the insulator between the electrode 22 and the shell 36 or between the electrode 22 and the cylinder head 48. Thus, the corona igniter 20 provides a more concentrated corona discharge 24 at the firing tip 58 and a more robust ignition, compared to corona igniters of the prior art.

Another aspect of the invention provides a method of forming the corona igniter 20. The method first includes providing the central electrode 22, the insulator 32, and the shell 36. The method then includes inserting the electrode firing end 70 of the central electrode 22 past the insulator upper end 60 and into the insulator bore and spacing the central electrode 22 from the insulator 32 at the insulator nose end 62 to provide the electrode gap 28 therebetween.

After inserting the central electrode 22 in the insulator 32, the method includes inserting the insulator 32 past the shell upper end 44 and into the shell bore. The inserting step includes sliding the insulator nose end 62 past the shell lower end 92, spacing the insulator 32 from the shell 36, and providing a shell gap 30 therebetween. In one embodiment, the method includes disposing the internal seal 38 on the shell seat 96 in the shell bore, and the spacing step includes disposing the insulator 32 on the internal seal 38 to provide the shell gap 30. The method also includes forming the shell 36 about the insulator 32. In one embodiment, the method includes disposing the internal seal 38 on the insulator upper shoulder 78 and the forming step includes bending the shell upper end 44 radially inwardly around the internal seal 38 toward the insulator first region 74 to provide the turnover lip 42.

After inserting the insulator 32 in the shell 36, the method includes filling at least one of the gaps 28, 30 with a filler material 40, and preferably both the electrode gap 28 and the shell gap 30. The filling step can include pumping the filler material 40 into the electrode gap 28 and the shell gap 30, and injection molding the filler material 40 around the turnover lip 42 of the shell 36 at the shell upper end 44.

Obviously, many modifications and variations of the present invention are possible in light of the above teachings and may be practiced otherwise than as specifically described while within the scope of the appended claims. In addition, the reference numerals in the claims are merely for convenience and are not to be read in any way as limiting.

What is claimed is:

1. A corona igniter (20) for providing a corona discharge (24), comprising:
a central electrode (22) formed of an electrically conductive material for receiving a high radio frequency voltage and emitting a radio frequency electric field to ionize a fuel-air mixture and provide a corona discharge (24),
said central electrode (22) extending from an electrode terminal end (52) receiving the high radio frequency voltage to an electrode firing end (54) emitting the radio frequency electric field,
an insulator (32) formed of an electrically insulating material disposed around said central electrode (22) and extending longitudinally from an insulator upper end (60) past said electrode terminal end (52) to an insulator nose end (62),
said insulator (32) being spaced from said central electrode (22) at said insulator nose end (62) to provide an electrode gap (28) therebetween,
a shell (36) formed of an electrically conductive metal material disposed around said insulator (32) and extending longitudinally from a shell upper end (44) to a shell lower end (92),
said shell (36) being spaced from said insulator (32) along at least one of said shell ends (44, 92) to provide a shell gap (30) therebetween,
a filler material (40) extending continuously across at least one of said gaps (28, 30) for preventing corona discharge (24) in said gap (28, 30).

2. The igniter (20) of claim 1 wherein said filler material (40) hermetically seals said gap (28, 30).

3. The igniter (20) of claim 1 wherein an least one internal seal (38) formed of a seal material different from said filler material (40) is disposed along a portion of said shell (36) for spacing said insulator (32) from said shell (36) and providing said shell gap (30) extending continuously between said shell upper end (44) and said shell lower end (92).

4. The igniter (20) of claim 3 wherein said filler material (40) is disposed around said internal seal (38).

5. The igniter (20) of claim 1 said filler material (40) has a voltage varying across said gap (28, 30) by not greater than 5% of a total voltage drop from said central electrode (22) to said shell (36) and wherein said filler material (40) has an electric field in said gap (28, 30) of not greater than one times higher than an electrode field strength of said insulator (32) when a current of energy at a frequency of 0.5 to 5.0 megahertz flows through said central electrode (22).

6. The igniter (20) of claim 1 wherein said filler material (40) and said insulator (32) each have a relative permittivity and wherein the difference between the relative permittivity of said filler material (40) and the relative permittivity of said insulator (32) is not greater than 10.

7. The igniter (20) of claim 1 wherein said filler material (40) and said insulator (32) each have a coefficient of thermal expansion and wherein the difference between the coefficient of thermal expansion of said filler material (40) and the coefficient of thermal expansion of said insulator (32) is not greater than 10×10⁻⁶/° C.

8. The igniter (20) of claim 1 wherein said gap (28, 30) has a volume and said filler material (40) fills at least 50% of the volume of said gap (28, 30).

9. The igniter (20) of claim 1 wherein said filler material (40) is electrically insulating.

10. The igniter (20) of claim 1 wherein said filler material (40) includes at least one of a plastic, a resin, a glass powder, and an adhesive including alumina.

11. The igniter (20) of claim 1 wherein said filler material (40) is electrically conductive.

12. The igniter (20) of claim 11 wherein said filler material (40) includes at least one of a nickel-cobalt ferrous alloy, stainless steel, chromium, and adhesive filled with metal powder.

13. The igniter (20) of claim 1 wherein said filler material (40) is disposed in said electrode gap (28),
said electrode body portion (56) has a length (lₑ) from said electrode firing end (54) to said electrode terminal end (52) and said electrode gap (28) extends along at least 90% of said length (lₑ) and has a volume,
said filler material (40) fills at least 50% of the volume of said electrode gap (28),
said central electrode (22) includes a firing tip (58) spaced from said insulator nose end (62) surrounding and adjacent said electrode firing end (54) for emitting the radio frequency electric field,
said electrode gap (28) is open at said insulator nose end (62) allowing air to flow along said firing tip (58) to said electrode gap (28),
said electrode gap (28) extends annularly around said electrode body portion (56),
said electrode gap (28) has an electrode gap width (wₑ) extending perpendicular to said electrode center axis (aₑ) from said electrode body portion (56) to said insulator (32),
said electrode gap width (wₑ) being from 0.025 to 0.25 mm.
a portion of said electrode body portion (56) adjacent said filler material (40) has a voltage and a portion of said insulator (32) adjacent said filler material (40) has a voltage and wherein the difference between the voltages is not greater than 5% of a total voltage drop from said central electrode (22) to said shell (36) when a current of energy at a frequency of 0.5 to 5.0 megahertz flows through said central electrode (22).

14. The igniter (20) of claim 1 wherein said filler material (40) is disposed in said shell gap (30),
said shell (36) has a length (lₛ) from said shell lower end (92) to said shell upper end (44) and said shell gap (30) extends along at least 50% of said length (lₛ) and has a volume,
said filler material (40) fills at least 50% of the volume said shell gap (30),
said shell gap (30) is open at said shell lower end (92) and said shell upper end (44) allowing air to flow along said shell gap (30),
said shell gap (30) extends annularly around said insulator (32),
said shell gap (30) has a shell gap width (wₛ) extending perpendicular to said electrode center axis (aₑ) from said insulator (32) to said shell (36),
said shell gap width (wₛ) is from 0.075 to 0.30 mm, and
a portion of said insulator (32) adjacent said filler material (40) has a voltage and a portion of said shell (36) adjacent said filler material (40) has a voltage and wherein the difference between the voltages is not greater than 5% of a total voltage drop from said central electrode (22) to said shell (36) when a current of energy at a frequency of 0.5 to 5.0 megahertz flows through said central electrode (22).

15. The igniter (20) of claim 1 wherein said shell gap (30) has a shell gap width (wₛ) extending form said shell (36) to said insulator (32) and said shell gap width (wₛ) is greatest at said shell lower end (92) and said filler material (40) is disposed in said shell gap (30) at said shell lower end (92).

16. The igniter (20) of claim 1 wherein said shell (36) is spaced from said insulator (32) at said shell upper end (44) to present said shell gap (30) and said filler material (40) includes a resin molded around said shell gap (30).

17. A corona ignition system for providing a radio frequency electric field to ionize a portion of a fuel-air mixture and provide a corona discharge (24) in a combustion chamber (26) of an internal combustion engine, comprising:
a cylinder block (46) and a cylinder head (48) and a piston (50) providing a combustion chamber (26) therebetween,
a mixture of fuel and air provided in said combustion chamber (26),
an igniter (20) disposed in said cylinder head (48) and extending transversely into said combustion chamber (26) for receiving a high radio frequency voltage and emitting a radio frequency electric field to ionize a portion of the fuel-air mixture and form said corona discharge (24),
said igniter (20) including a central electrode (22) formed of an electrically conductive material for receiving a high radio frequency voltage and emitting a radio frequency electric field to ionize a fuel-air mixture and provide said corona discharge (24),
said central electrode (22) extending from an electrode terminal end (52) receiving the high radio frequency voltage to an electrode firing end (54) emitting the radio frequency electric filed,
an insulator (32) formed of an electrically insulating material disposed around said central electrode (22) and extending longitudinally from an insulator upper end (60) past said electrode terminal end (52) to an insulator nose end (62),
said insulator (32) being spaced from said central electrode (22) at said insulator nose end (62) to provide an electrode gap (28) therebetween,
a shell (36) formed of an electrically conductive metal material disposed around said insulator (32) and extending longitudinally from a shell upper end (44) to a shell lower end (92),
said shell (36) being spaced from said insulator (32) along at least one of said shell ends (44, 92) to provide a shell gap (30) therebetween,
a filler material (40) extending continuously across at least one of said gaps (28, 30) for preventing corona discharge (24) in said gap (28, 30).

18. A method of forming a corona igniter (20), comprising the steps of:
providing an insulator (32) formed of an electrically insulating material and presenting an insulator bore extending longitudinally from an insulator upper end (60) to an insulator nose end (62),
inserting a central electrode (22) formed of an electrically conductive material into the insulator bore,
spacing the central electrode (22) from the insulator (32) at the insulator nose end (62) to provide an electrode gap (28) therebetween,
providing a shell (36) formed of a metal material and presenting a shell bore extending longitudinally from a shell upper end (44) to a shell lower end (92),
inserting the insulator (32) into the shell bore,
spacing the insulator (32) from the shell (36) and providing a shell gap (30) therebetween, and
filling at least one of the gaps (28, 30) with a filler material (40).

19. The method of claim 18 wherein the filling step includes injection molding the filler material (40) around the shell (36) at the shell upper end (44).

20. The method of claim 18 including disposing an internal seal (38) on the shell (36) in the shell bore and wherein the spacing step includes disposing the insulator (32) on the internal seal (38) to provide the shell gap (30).
